(19) United States
(12) Patent Application Publication
(10) Pub. No.: US 2018/0174260 A1
(43) Pub. Date: Jun. 21, 2018

(54) METHOD AND APPARATUS FOR CLASSIFYING PERSON BEING INSPECTED IN SECURITY INSPECTION

(71) Applicant: Nuctech Company Limited, Beijing (CN)

(72) Inventors: Jin CUI, Beijing (CN); Huabin TAN, Beijing (CN)

(21) Appl. No.: 15/817,613

(22) Filed: Nov. 20, 2017

(30) Foreign Application Priority Data
Dec. 8, 2016 (CN) 201611123767.9

(51) Int. Cl. G06Q 50/26; G06N 99/00

(52) U.S. Cl. CPC G06Q 50/265; G06N 99/005

(57) ABSTRACT

The present disclosure discloses a method and an apparatus for classifying a person being inspected in security inspection. The method for classifying a person being inspected in security inspection comprises: generating, from historical security inspection information, a risk identification model of persons being inspected; acquiring security associated factor information of the current person being inspected; generating by means of data cleaning, from the security associated factor information, a security associated feature set; and determining in real time, according to the security associated feature set and the risk identification model, the risk level of the current person being inspected. The method for classifying a person being inspected in security inspection of the present disclosure enables the improvement of security inspection efficiency and the implementation of a differential inspecting on the person being inspected.

### CROSS REFERENCE TO RELATED APPLICATION

This application is based upon and claims priority to Chinese Patent Application No. 201611123767.9, filed on Dec. 8, 2016, the entire contents thereof are incorporated herein by reference.

### TECHNICAL FIELD

The present disclosure relates to the field of large data information processing, and in particular, to a method and an apparatus for classifying a person being inspected in security inspection.

### BACKGROUND

Security inspection in key locations is an important protective measure to guarantee the safety of passengers. Key locations for security inspection may comprise borders, customs, subways, stations and so on. As security inspection is an important protective measure to guarantee the safety of passengers, all the passengers to enter a key location must go through inspection before they are allowed to enter, without exception. Security inspection is also an inspection procedure passengers must go through.

During security inspection in public places such as roads, railway stations, airports and so on, the security staff can verify the identity of a person being inspected by inspecting the identity card and other documents to confirm whether the person being inspected is present in a list of suspicious persons from the public security department. Furthermore, for example, the security staff may use a radioactive ray (such as an X-ray) generated by a specific device (such as security machine) to scan the baggage of the person being inspected, and determine, according to the scanned image, whether the baggage carried by the passenger contains dangerous goods or prohibited articles. Furthermore, for example, the security staff may use a body inspection device to conduct a physical inspection of a suspected passenger to inspect whether the suspected passenger carries a metal or other prohibited article. In short, the current security inspection process is cumbersome and takes a long time, bringing not only bad security inspection experience to passengers, but also a lot of inefficient repetitive work to the security staff.

Accordingly, there is a need for a method and an apparatus for classifying a person being inspected in security inspection.

The above-mentioned information disclosed in the background section is only for the purpose of enhancing the understanding of the background of the present disclosure and may therefore comprise information that does not constitute prior art known to those of ordinary skill in the art.

This section provides background information related to the present disclosure which is not necessarily prior art.

### SUMMARY

In view of the above, the present disclosure provides a method and an apparatus for classifying a person being inspected in security inspection, which can improve security inspection efficiency and perform differentiated inspection on persons being inspected.

Other characteristics and advantages of the present disclosure will become apparent from the following detailed description, or will be learned, in part, by practice of the present disclosure.

According to an aspect of the present disclosure, there is provided a method for classifying a person being inspected in security inspection, characterized by comprising: generating, from historical security inspection information, a risk identification model of persons being inspected; acquiring security associated factor information of the current person being inspected; generating by means of data cleaning, from the security associated factor information, a security associated feature set; and determining in real time, according to the security associated feature set and the risk identification model, the risk level of the current person being inspected.

In an exemplary embodiment of the present disclosure, generating, from historical security inspection information, a risk identification model of persons being inspected, includes: acquiring historical security inspection information; marking, according to the actual security inspection result, the corresponding entry in the historical security inspection information; and storing the historical security inspection information and the marked entry in the historical security inspection information into a sample library.

In an exemplary embodiment of the present disclosure, generating, from historical security inspection information, a risk identification model of persons being inspected, includes: generating by means of data cleaning, from the sample library, the security associated feature set; and generating, by means of a machine learning algorithm, the risk identification model.

In an exemplary embodiment of the present disclosure, the machine learning algorithm includes a support vector machine algorithm. In an exemplary embodiment of the present disclosure, the security associated factor information includes social relationship information, security inspection clue information, and Internet behavior clue information.

In an exemplary embodiment of the present disclosure, generating by means of data cleaning, from the security associated factor information, a security associated feature set, includes: obtaining by means of data cleaning, from the security associated factor information, data information of a predetermined format; and generating, from the information of a predetermined format, the security associated feature set.

In an exemplary embodiment of the present disclosure, determining in real time, according to the security associated feature set and the risk identification model of the person being inspected, the risk level of the person being inspected, includes: obtaining in real time, by means of distributed system infrastructure and a real-time computation framework, the risk level of the person being inspected.

In an exemplary embodiment of the present disclosure, the distributed system infrastructure includes Apache Hadoop architecture.

In an exemplary embodiment of the present disclosure, the real-time computation framework includes Spark architecture.

In an exemplary embodiment of the present disclosure, the support vector machine algorithm is trained by Spark Mllib technology.

In an exemplary embodiment of the present disclosure, in the support vector machine algorithm, the ratio of the data amount of the training data to the data amount of the test data is 6-8:2-4.

According to an aspect of the present disclosure, there is provided an apparatus for classifying a person being inspected in security inspection, including: a model generation module configured to generate, from historical security inspection information, a risk identification model of persons being inspected; an information reception module configured to acquire security associated factor information of the current person being inspected; a data cleaning module configured to generate by means of data cleaning, from the security associated factor information, a security associated feature set; and a risk classification module configured to determine in real time, according to the security associated feature set and the risk identification model, the risk level of the current person being inspected.

In an exemplary embodiment of the present disclosure, the model generation module further includes: a historical information sub-module configured to acquire historical security inspection information; a marking sub-module configured to mark, according to the actual security inspection result, the corresponding entry in the historical security inspection information; and a storage sub-module configured to store the historical security inspection information and the marked entry in the historical security inspection information into a sample library; a data cleaning sub-module configured to generate by means of data cleaning, from the sample library, the security associated feature set; and an algorithm sub-module configured to generate, by means of a machine learning algorithm, the risk identification model.

According to the method for classifying a person being inspected in security inspection of the present disclosure, by acquiring the relevant information of a person being inspected and combining the relevant data analysis method, security efficiency can be improved, and a differential examination can be performed on the person being inspected.

It is to be understood that both the foregoing general description and the following detailed description are exemplary only and do not limit the present disclosure.

This section provides a summary of various implementations or examples of the technology described in the disclosure, and is not a comprehensive disclosure of the full scope or all features of the disclosed technology.

### BRIEF DESCRIPTION OF THE DRAWINGS

The foregoing and other objects, features and advantages of the present disclosure will become more apparent from the following detailed description of exemplary embodiments thereof with reference to the accompanying drawings. The drawings described below are merely some embodiments of the present disclosure, and other drawings may be obtained from these drawings by those of ordinary skill in the art without inventive work.

FIG. 1 is a flow chart of a method for classifying a person being inspected in security inspection according to an exemplary embodiment.

FIG. 2 is a flow chart of a method for classifying a person being inspected in security inspection according to another exemplary embodiment.

FIG. 3 is a block diagram of an apparatus for classifying a person being inspected in security inspection according to an exemplary embodiment.

FIG. 4 is a block diagram of an apparatus for classifying a person being inspected in security inspection according to another exemplary embodiment.

### DETAILED DESCRIPTION

The exemplary embodiments will now be described more comprehensively with reference to the accompanying drawings. However, the exemplary embodiments can be embodied in a variety of forms and should not be construed as being limited to the embodiments set forth herein; rather, these embodiments are provided so that the present disclosure will be thorough and complete, and the concepts of exemplary embodiments will be fully conveyed to those skilled in the art. The same reference signs in the drawings denote the same or similar parts, and thus repeated description thereof will be omitted.

In addition, the features, structures, or characteristics described may be combined in one or more embodiments in any suitable manner. In the following description, numerous specific details are set forth to give a full understanding of the embodiments of the present disclosure. However, those skilled in the art will appreciate that the technical solutions of the present disclosure may be practiced without one or more of particular details, or using other methods, components, devices, steps, and the like. In other instances, well-known methods, devices, implementations, or operations are not shown or described in detail to avoid obscuring aspects of the present disclosure.

The block diagrams shown in the drawings are merely functional entities and do not necessarily have to correspond to physically separate entities. That is, these functional entities may be implemented in software form, or implemented in one or more hardware modules or integrated circuits, or implemented in different networks and/or processor devices and/or microcontroller devices.

The flowcharts shown in the drawings are merely illustrative and do not necessarily comprise all of the contents and operations/steps, nor must they be performed in the order described. For example, some operations/steps may also be decomposed, and some operations/steps may be combined or partially merged, so that the actual execution order may change according to the actual situation.

It is to be understood that although the terms, first, second, third, etc., may be used herein to describe various components, the components should not be limited by these terms. These terms are used to distinguish between one component and another. Thus, a first component discussed below may be referred to as a second component without departing from the teachings of concepts of the present disclosure. As used herein, the term and/or comprises any one of the listed associated items and all combinations of one or more.

It will be understood by those skilled in the art that the drawings are merely schematic diagrams of exemplary embodiments and that the modules or processes in the drawings are not certainly necessary to the implementation of the present disclosure and are therefore not intended to limit the scope of the present disclosure.

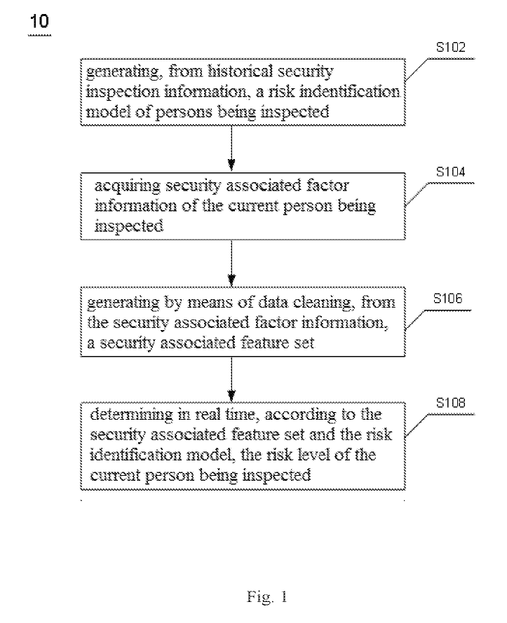

FIG. 1 is a flow chart of a method for classifying a person being inspected in security inspection according to an exemplary embodiment.

As shown in FIG. 1, in S102, a risk identification model of persons being inspected is generated from historical security inspection information. The historical security inspection information may comprise social relationship information, security inspection clues, and Internet behavior clues, etc., of the persons being inspected. Furthermore, for example, through a large data analysis method, a machine learning algorithm is used to extract information concerning persons being inspected from previous mass historical security inspection information about people passing security inspection stations, so as to establish the risk identification model of the persons being inspected. The risk identification model makes a risk judgment of a person being inspected according to the relevant information of persons being inspected and provides a risk level of the person being inspected.

In S104, security associated factor information of the current person being inspected is acquired. In the actual security inspection process, for example, when the person being inspected passes through a human-certificate verification gating machine, the human-certificate verification gating machine acquires identity card information, and establishes communication with a security inspection server to acquire the security associated factor information of that person. The security associated factor information may comprise: social relationship information, security inspection clues, Internet behavior clues, etc.

In S106, a security associated feature set is generated from the security associated factor information by means of data cleaning.

Data cleaning is performed on the security associated factor information. For example, data information of a predetermined format may be obtained after data cleaning, and the security associated feature set may be generated from the information of a predetermined format. Data cleaning is a process of re-examining and verifying data, with the purpose of deleting duplicate information, correcting existing errors, and providing data consistency. For example, ETL data cleaning technology may be used. ETL data cleaning is the process of data extraction, data transformation and data loading. Data extraction is responsible for finding from a data source and extracting the part of data required by the present subject matter, and since data in the various subject matters in a database are stored according to the requirements of front-end applications, the extracted data need to be transformed to meet the need of the front-end applications. The transformed data can be loaded into the database. The data loading process is performed at regular intervals, and data loading tasks of different subject matter have their own different execution schedules. ETL data cleaning is an important part of building a database. Database is a subject matter-oriented, integrated, stable, and time-varying data set to support the decision making process in business management. Database is mainly used for decision analysis, providing decision support information to leaders. There may be a lot of “dirty data” in a database system. The main causes of “dirty data” are abuse of abbreviations and idioms, data input errors, duplicate records, lost values, spelling changes, different units of measure, and outdated coding and so on. To clear “dirty data”, data cleaning must be performed in the database system. Data cleaning is a process that reduces errors and inconsistencies and resolves object recognition. The security associated feature set is data information set generated from the security associated factor information of persons being inspected, by means of data cleaning, with the information irrelevant to security factors being removed.

In S108, the risk level of the person being inspected is determined, in real time, according to the security associated feature set and the risk identification model.

As described above, for example, the human certificate verification gate obtains the identity card information, establishes communication with the security inspection server, obtains the person's security associated factor information, and obtains the security associated feature set through data cleaning. The risk level of the person being inspected can be computed in real time by combining and importing the security associated feature set of the person being inspected into the risk identification model. The risk level can be, for example, classified as three-level: secure, suspected, and focused. The present disclosure is not limited thereto. For example, a differentiated detection may be performed on the person being inspected according to the obtained security inspection classification result, combining the actual situation on site. For example, one at the secure level passes through security inspection quickly, one at the suspected level passes through security inspection as normal, and one at the focused level will be attentively interrogated and inspected by using a body inspection device. Furthermore, for example, in order to improve the accuracy of the personnel risk identification model and the timeliness of the computation of the security level of the person being inspected, the real-time computation of the security level of the person being inspected may be implemented, for example, created based on large data technology, deploying the analysis system on the Apache Hadoop and Spark architectures.

According to the method for classifying a person being inspected in security inspection in the present disclosure, by acquiring the relevant information of the person being inspected and combining the relevant data analysis method, security inspection efficiency can be improved, and a differential examination may be performed on the person being inspected.

It is to be clearly understood that the present disclosure describes how specific examples are formed and used, but the principles of the present disclosure are not limited to any of these examples. In contrast, these principles can be applied to many other embodiments, based on the teachings of the present disclosure.

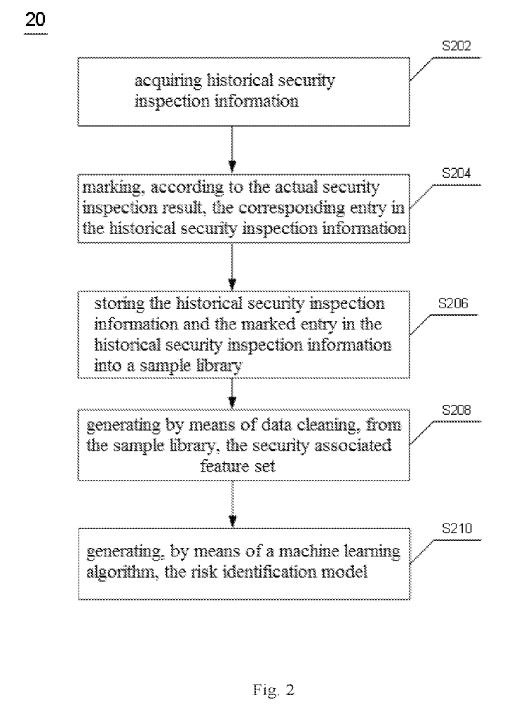

FIG. 2 is a flow chart of a method for classifying a person being inspected in security inspection according to another exemplary embodiment. The method shown in FIG. 2 is an exemplary description of S102 shown in FIG. 1.

In S202, historical security inspection information is acquired. The acquisition gathers historical security inspection information of persons in security inspection stations. The historical security inspection information may comprise security associated factor information. The security associated factor information may comprise social relationship information, security inspection clues and Internet behavior of the person being inspected.

In S204, the corresponding entry in the historical security inspection information is marked according to the actual security inspection result. The corresponding record in security inspection information is marked according to the actual security inspection result.

In S206, the historical security inspection information and the marked entry in the historical security inspection information are stored into a sample library. The marked historical security inspection information is stored into a model sample library.

In S208, the security associated feature set is generated from the sample library by means of data cleaning. Data information of a predetermined format is obtained, by means of data cleaning, from the data in the sample library, such as data of the security associated factor information; and the security associated feature set is generated from the information of a predetermined format.

In S210, a risk identification model is generated by means of a machine learning algorithm. For example, by means of a Support Vector Machine (SVM) algorithm, the above data may be processed to further generate the risk identification model of the person being inspected. The SVM method maps a sample space to a high-dimensional and infinite-dimensional feature space (Hilbert space) through a nonlinear mapping p, so that the nonlinear separable problem in the original sample space is transformed into the linear separable problem in the feature space. Simply speaking, that is, dimension raising and linearization. Dimension raising refers to mapping a sample to a higher-dimensional space, which, under normal circumstances, will increase computation complexity, and even lead to “dimension disaster”, so that few people are interested. However, with respect to classification and regression problems, it is possible that the sample set, which cannot be processed linearly in a low-dimensional sample space, can be linearly divided or regressed through a linear hyperplane in a high-dimensional feature space. General dimension raising leads to computation complexity. The SVM method applies the expansion theorem of the kernel function, without the need to know the explicit expression of the nonlinear mapping; since a linear learning machine is established in the high-dimensional feature space, compared to the linear model, not only computation complexity is almost not increased, but also “dimension disaster” can be avoided to some extent.

During the computation of the risk identification model of persons, the machine learning algorithm of Spark MLlib's Support Vector Machine (SVM) algorithm is used. The algorithm can be transformed to an problem of seeking for a minimal value of a convex function (the classification error being minimal), namely, MIN_{wϵR}_{^{d}}f(w). The objective function f has the following form:

$$f ( w ) := λ R ( w ) + \frac{1}{n} {\sum }_{i = 1}^{n} L ( w ; {x}_{i} , {y}_{i} )$$

Where the vector xᵢϵR^{d} is the training data sample, where 1≤i≤n, n is the number of samples. yᵢϵR is the predicted target, namely, the person's security level.

For example, a model training may be performed using the following security associated feature set to which ETL cleaning is performed, and the security feature set may comprise, for example, the following information “security level, nationality information, age, gender, address, historical security inspection result”. For example, some security feature set is “0 3 28 1 54 0 . . . ”, where the data has the following meaning:

0 representing the marked security level, for example, for the security level, 0: secure; 1: suspected; 2: focused;

2 representing the nationality information, for example, for the nationality information, Xinjiang: 0; Tibetan: 1; Hui: 2; Han: 3; other: 4;

28 representing age;

1 representing gender, for example, 0: female; 1: male;

54 representing address, for example, 01: Beijing; 02: Tianjin; . . . 54: Baoding;

0 representing the historical security inspection result, for example, 0: not securely suspected; 1: securely suspected;

During inputting the above information into the support vector machine model, the data training is performed, and after training, the human risk identification model is obtained.

In an exemplary embodiment of the present disclosure, the security associated factor information comprises social relationship information, security inspection clue information, and Internet behavior clue information. The process of collecting the security associated factor information of the persons being inspected may, for example, be as follows:

1) reading the identity card of the person being inspected by means of a human-certificate verification device, the device reading, from the identity card information, the identity card number, gender, nationality, date of birth, address and other information;

2) with the identity card number, acquiring, by means of a security inspection information database, previous security inspection clue information concerning security inspection items, driving vehicles, driving paths and so on;

3) with the identity card number, acquiring, by means of an information database of the public security department, social relationship like family, job, residential address, Internet bar and so on;

4) by means of an Internet information database, acquiring that person's weblog, WeChat public account, posts in Post bar, replies, comments and other Internet information;

5) gathering the above information to generate security associated factor information of the person.

In an exemplary embodiment of the present disclosure, the risk level of the person being inspected is determined in real time according to the security associated feature set and the person's risk identification model, comprising: obtaining, in real time, the risk level of the person being inspected through distributed system infrastructure and a real-time computation framework. In one exemplary embodiment of the present disclosure, the distributed system infrastructure comprises an Apache Hadoop architecture. Apache Hadoop is a set of frameworks for running applications on large clusters built with general-purpose hardware. It implements the Map/Reduce programming paradigm, and the computational tasks are split into small blocks (many times) running on different nodes. In addition, it further provides a distributed file system (HDFS), and the data is stored on the computing nodes to provide very high cross-data center aggregated bandwidth. In an embodiment of the present disclosure, it is also possible to use, for example, Hbase technology to store and access the information of the person being inspected. HBase is a distributed, column-oriented open source database, and the technology comes from Fay Chang's Google paper “Bigtable: A Distributed Data Storage System for Structured Data”. HBase provides a capability similar to Bigtable (distributed data storage system) on top of Hadoop. HBase is a subproject of Apache's Hadoop project. HBase is different from a general relational database, and is a database suitable for unstructured data storage. The other difference is that HBase is column-based rather than row-based mode. In an embodiment of the present disclosure, it is possible to use the related technologies such as HDFS and Hbase to realize the storage and access of the information of the person being inspected, and the present disclosure is not limited thereto.

The method for classifying a person being inspected in security inspection according to the present disclosure can realize the storage and the access of the security associated factor information of a huge number of persons, through the Apache Hadoop architecture and the related technology.

In an exemplary embodiment of the present disclosure, a real-time computation framework comprises Spark architecture. Spark is a general-purpose parallel framework for the open source class Hadoop MapReduce of UC Berkeley AMP lab. Spark has the advantages of Hadoop MapReduce; but unlike MapReduce, the mediate output result of Job can be saved in the memory, so that there is no need to read and write HDFS, whereby Spark can be better applied to algorithms needing iteration, such as data mining, machine learning, and the like. Spark Streaming is a real-time computation framework built on Spark, and through the rich APIs provided thereby and a memory-based high-speed execution engine, users can combine streaming, batch and interactive query applications. The basic principle of Spark Streaming is to split input data streams in units of time slices (seconds), and then process each time slice of data in a batch processing-like manner. Spark Streaming decomposes the dreaming computation into multiple subunits, and the processing of each segment of data experiences diagram-decomposition and the scheduling process of the Spark's task set. For the current version of Spark Streaming, its smallest Batch Size is selected between 0.5 and 2 seconds, so Spark Streaming is able to meet the needs of all streaming quasi-real-time computation scenarios except for those with very high real-time requirements (such as high-frequency real-time transactions).

The method for classifying a person being inspected in security inspection according to the present disclosure enables the real-time computation of the security level of the person being inspected through the Spark architecture and the related technology.

In one exemplary embodiment of the present disclosure, the support vector machine algorithm performs training by Spark Mllib technology. MLlib is Spark's library of implementations of commonly used machine learning algorithms, simultaneously comprising related test and data generators. MLlib currently supports four common machine learning problems: binary classification, regression, clustering, and collaborative filtering, and meanwhile also comprises an underlying gradient reduction optimization basic algorithm.

The method for classifying a person being inspected in security inspection according to the present disclosure enables the implementation of offline training of the risk identification model of the person being inspected by performing the data training of the support vector machine algorithm by Spark MLlib technology.

In an exemplary embodiment of the present disclosure, in the support vector machine algorithm, the ratio of the data amount of the training data to the data amount of the test data is 6-8: 2-4. The machine learning training model used is 10 times faster than the previous technology, and the security classification identification time is controlled within 10 milliseconds.

Those skilled in the art will appreciate that all or part of the steps to implement the above embodiments are implemented as a computer program executed by CPU. When the computer program is executed by CPU, the above-described functions defined by the above-described method provided by the present disclosure are executed. The program may be stored in a computer-readable storage medium, which may be a read-only memory, a magnetic disk, an optical disk, or the like.

In addition, it is to be noted that the above drawings are only illustrative of the processes comprised in the method according to the exemplary embodiments of the present disclosure and are not intended to be limiting. It is easy to understand that these processes shown in the above drawings do not indicate or limit the chronological order of these processes. In addition, it is also easy to understand that these processes may be, for example, performed synchronously or asynchronously in a plurality of modules.

The following is about the apparatus embodiments of the present disclosure, which can be used to carry out the method embodiments of the present disclosure. For the details that are not disclosed in the apparatus embodiments of the present disclosure, refer to the method embodiments of the present disclosure.

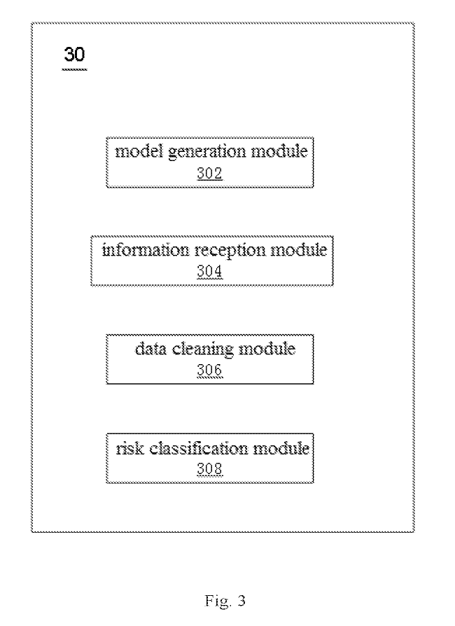

FIG. 3 is a block diagram of an apparatus for classifying a person being inspected in security inspection according to an exemplary embodiment. As shown in FIG. 3, the apparatus 30 for classifying a person being inspected comprises a model generation module 302, an information reception module 304, a data cleaning module 306, and a risk classification module 308.

The model generation module 302 is used to generate a risk identification model of the person being inspected from historical security inspection information.

The information reception module 304 is used to acquire the security associated factor information of the current person being inspected.

The data cleaning module 306 is used to generate the security associated feature set by data cleaning the security associated factor information.

The risk classification module 308 is used to determine, in real time, the risk level of the person being inspected according to the security associated feature set and the risk identification model.

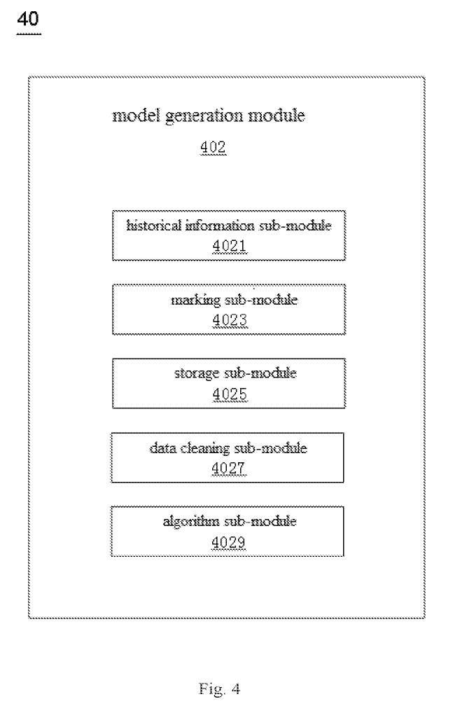

FIG. 4 is a block diagram of an apparatus for classifying a person being inspected in security inspection according to another exemplary embodiment. FIG. 4 is an exemplary description of the model generation module 302 in FIG. 3. The model generation module 402 comprises:

a historical information sub-module 4021 configured to acquire the historical security inspection information.

a mark sub-module 4023 configured to mark the corresponding entry in the historical security inspection information according to the actual security inspection result.

a storage sub-module 4025 configured to store the historical security inspection information and the marked entry in the historical security inspection information into the sample library.

a data cleaning sub-module 4027 configured to generate a security associated feature set by data cleaning a sample library.

an algorithm sub-module 4029 configured to generate a risk identification model through a machine learning algorithm.

It will be understood by those skilled in the art that the above-described modules may be distributed in devices according to the description of the embodiments, and may also be modified in a manner different from one or more devices of the present embodiments. The modules of the above embodiments may be combined into one module and may also be further split into a plurality of sub-modules.

With the description of the embodiments hereinabove, it will be readily understood by those skilled in the art that the exemplary embodiments described herein may be implemented by software, and may also be implemented by software in conjunction with necessary hardware. Thus, the technical solution according to the embodiments of the present disclosure may be embodied in the form of a software product which may be stored on a nonvolatile storage medium (which may be a CD-ROM, a U disk, a mobile hard disk, etc.) or on a network, and comprises a number of instructions to enable a computing device (which may be a personal computer, a server, a mobile terminal, or a network device, etc.) to perform the method according to the embodiments of the present disclosure.

With the foregoing detailed description, it will be readily understood by those skilled in the art that the method and apparatus for classifying a person being inspected in security inspection according to the embodiments of the present disclosure have one or more of the following advantages.

According to some embodiments, the method for classifying a person being inspected in security inspection of the present disclosure enables the improvement of security inspection efficiency and a differentiated inspection on the person being inspected, by acquiring the relevant information of the person being inspected combining the relevant data analysis method.

According to other embodiments, the method for classifying a person being inspected in security inspection of the present disclosure enables the storage and access of security associated factor information of a huge number of persons, through the Apache Hadoop architecture and the related technology.

According to other embodiments, the method for classifying a person being inspected in security inspection of the present disclosure enables the real-time computation of the security level of the person being inspected through the Spark architecture and the related technology.

The exemplary embodiments of the present disclosure have been specifically shown and described above. It is to be understood that the present disclosure is not limited to the detailed structure, arrangement, or method of implementation described herein; rather, the present disclosure is intended to cover various modifications and equivalent arrangements comprised within the spirit and scope of the appended claims.

In addition, the structure, proportion, size, etc. shown in the drawings of the specification are intended for the reading of those skilled in the art in conjunction with the content of the present disclosure, but are not intended to the implementation of the present disclosure, thereby having no essential technical meaning. Any modification in structure, change in proportion or adjustment in size shall fall within the range covered by the technical content of the present disclosure without influencing the technical effect produced by the present disclosure and the object that can be achieved. Meanwhile, the terms such as “above”, “first”, “second” and ‘a/an” in this specification, are merely illustrative and are not intended to limit the scope of the present disclosure, and the change or adjustment in relative relationship shall also be considered to be within the range of implementation of the present disclosure, without substantial modification of the technical contents.

1. A method for classifying a person being inspected in security inspection, comprising:
generating, from historical security inspection information, a risk identification model of persons being inspected;
acquiring security associated factor information of the current person being inspected;
generating by means of data cleaning, from the security associated factor information, a security associated feature set; and
determining in real time, according to the security associated feature set and the risk identification model, the risk level of the current person being inspected.

2. The method according to claim 1, wherein generating, from historical security inspection information, a risk identification model of persons being inspected comprises:
acquiring historical security inspection information;
marking, according to the actual security inspection result, the corresponding entry in the historical security inspection information; and
storing the historical security inspection information and the marked entry in the historical security inspection information into a sample library.

3. The method according to claim 1, wherein generating, from historical security inspection information, a risk identification model of persons being inspected comprises:
generating by means of data cleaning, from the sample library, the security associated feature set; and
generating, by means of a machine learning algorithm, the risk identification model.

4. The method according to claim 3, wherein the machine learning algorithm comprises:
a support vector machine algorithm.

5. The method according to claim 4, wherein the support vector machine algorithm performs training through Spark Mllib technology.

6. The method according to claim 1, wherein the security associated factor information comprises social relationship information, security inspection clue information, and Internet behavior clue information.

7. The method according to claim 1, wherein generating by means of data cleaning, from the security associated factor information, a security associated feature set comprises:
obtaining by means of data cleaning, from the security associated factor information, data information of a predetermined format; and
generating, from the information of a predetermined format, the security associated feature set.

8. The method according to claim 1, wherein determining in real time, according to the security associated feature set and the risk identification model, the risk level of the current person being inspected comprises:
obtaining in real time, by means of distributed system infrastructure and a real-time computation framework, the risk level of the person being inspected.

9. The method according to claim 8, wherein the distributed system infrastructure comprises:
Apache Hadoop architecture.

10. The method according to claim 8, wherein the real-time computation framework comprises:
Spark architecture.

11. The method according to claim 5, wherein in the support vector machine algorithm, the ratio of the data amount of the training data to the data amount of the test data is 6-8:2-4.

12. An apparatus for classifying a person being inspected in security inspection, comprising:
a model generation module for generating, from historical security inspection information, a risk identification model of persons being inspected;
an information reception module configured to acquire security associated factor information of the currently person being inspected;
a data cleaning module configured to generate by means of data cleaning, from the security associated factor information, a security associated feature set; and
a risk classification module configured to determine in real time, according to the security associated feature set and the risk identification model, the risk level of the current person being inspected.

13. The apparatus according to claim 12, wherein the model generation module further comprises:
a historical information sub-module configured to acquire the historical security inspection information;
a marking sub-module configured to mark, according to the actual security inspection result, the corresponding entry in the historical security inspection information;
a storage sub-module configured to store the historical security inspection information and the marked entry in the historical security inspection information into a sample library;
a data cleaning sub-module configured to generate by means of data cleaning, from the sample library, the security associated feature set; and
an algorithm sub-module configured to generate, by means of a machine learning algorithm, the risk identification model.

14. The method according to claim 2, wherein generating, from historical security check information, a risk identification model of checked persons comprises:
generating by means of data cleaning, from the sample library, the security associated feature set; and
generating, by means of a machine learning algorithm, the risk identification model.

15. The method according to claim 4, wherein the machine learning algorithm comprises: a support vector machine algorithm.

16. The method according to claim 6, wherein the support vector machine algorithm performs training through Spark Mllib technology.

17. The method according to claim 8, wherein in the support vector machine algorithm, the ratio of the data amount of the training data to the data amount of the test data is 6-8:2-4.

18. A non-transitory computer-readable storage medium storing instructions which, when executed by a processor, cause the processor to perform a method comprising:
generating, from historical security check information, a risk identification model of checked persons;
acquiring security associated factor information of the currently checked person;
generating by means of data cleaning, from the security associated factor information, a security associated feature set; and
determining in real time, according to the security associated feature set and the risk identification model, the risk level of the currently checked person.

19. The non-transitory computer-readable storage medium according to claim 18, wherein generating, from historical security check information, a risk identification model of checked persons comprises:
acquiring historical security check information;
marking, according to the actual security check result, the corresponding entry in the historical security check information; and
storing the historical security check information and the marked entry in the historical security check information into a sample library.
